(19) United States
(12) Patent Application Publication
(10) Pub. No.: US 2024/0114108 A1
(43) Pub. Date: Apr. 4, 2024

(54) VIDEO PROCESSING DEVICE AND VIDEO SIGNAL COMBINING DEVICE

(71) Applicant: LAPIS Technology Co., Ltd., Yokohama (JP)

(72) Inventors: Tomoyuki ICHIKAWA, Yokohama (JP); Naohiro FUJII, Yokohama (JP)

(73) Assignee: LAPIS Technology Co., Ltd., Yokohama (JP)

(21) Appl. No.: 18/470,374

(22) Filed: Sep. 19, 2023

(30) Foreign Application Priority Data
Sep. 29, 2022 (JP) 2022-156297

(51) Int. Cl. H04N 5/956

(52) U.S. Cl. CPC H04N 5/956

(57) ABSTRACT

The video signal combining device includes: multiple memory parts each having multiple line memories and respectively acquiring line data of video signals respectively input from multiple input terminals and sequentially writing and storing the acquired line data into the line memories, a reading control part sequentially reading the line data from any one of the line memories in a first-in-first-out manner, and a data output part outputting video combining data in which the line data read by the reading control part is connected. The reading control part reads the line data from determined one of the line memories based on a storage state of the line data in the line memories.

### CROSS-REFERENCE TO RELATED APPLICATION

This application claims priority under 35 USC 119 from Japanese Patent Application No. 2022-156297 filed on Sep. 29, 2022, the disclosure of which is incorporated by reference here.

### BACKGROUND

### Technical Field

The disclosure relates to a video processing device for processing video signals, and more particularly, to a video signal combining device for combining video signals.

### Description of Related Art

In recent years, car applications have seen a continuous increase in various input video sources, such as car navigation systems and back cameras. For instance, to compensate for dead angles of the vehicle, technologies have been developed to equip cameras on the front, back, left, and right sides of the vehicle and provide the driver with the captured videos on the driver's display. As an example, an image combining circuit (see Patent Document 1 (Japanese Patent Application Laid-Open (JP-A) No. 2012-138875), paragraph 0057) is known as an image processing device that is an integrated circuit such as ASIC which processes images, for combining four captured images to generate one combined image containing the content of all four captured images.

In the video processing LSI (large scale integrated circuit) of the video processing device, it is possible to consider a technique that combines multiple inputs into one output to reduce the number of camera ports. However, the simultaneous arrival of multiple input data in the LSI leads to the presence of input data queues, which require a large amount of memory to store the input data. Generally, the video combining output is enabled by equipping memory capable of storing a large amount of input data. However, this approach leads to an increase in the memory circuit area and a higher manufacturing cost.

Thus, in the video processing device that generates one combined image containing the content of all captured images, there is a problem related to the increase in memory circuit area when using a large amount of memory to combine multiple input video signals and generate video combining data, thereby increasing the manufacturing cost of the LSI.

The disclosure provides a video processing device and a video signal combining device that are capable of reducing the memory circuit area when generating video combining data by combining multiple input video signals using the memory.

### SUMMARY

A video signal combining device according to the disclosure includes: a plurality of memory parts, each having a plurality of line memories, and respectively acquiring line data of video signals respectively input from a plurality of input terminals and sequentially writing and storing the acquired line data into the line memories; a reading control part, sequentially reading the line data from any one of the line memories in a first-in-first-out manner; and a data output part, outputting video combining data in which the line data read by the reading control part is connected. The reading control part reads the line data from determined one of the line memories based on a storage state of the line data in the line memories.

A video processing device according to the disclosure includes: a plurality of memory parts, each having a plurality of line memories, and respectively acquiring line data of video signals respectively input from a plurality of input terminals and sequentially writing and storing the acquired line data into the line memories; a reading control part, sequentially reading the line data from any one of the line memories in a first-in-first-out manner and reading the line data from determined one of the line memories based on a storage state of the line data in the line memories; a data output part, outputting video combining data in which the line data read by the reading control part is connected; and a video processing part, processing the output video combining data.

### BRIEF DESCRIPTION OF THE DRAWINGS

FIG. 1 is a schematic block diagram illustrating an example of a video processing system including a video signal combining device and a video processing device connected to the same according to an embodiment.

FIG. 2 is a block diagram illustrating the overview of the video signal combining device according to an embodiment.

FIG. 3 is a block diagram illustrating the video signal combining device according to an embodiment.

FIG. 4 is a diagram illustrating an example of the relationship between the input video signals (frame time and line time) and the frame rate of the video in the video signal combining device according to an embodiment.

FIG. 5 is a diagram illustrating the generation operation of the combined video signal performed by the video signal combining device according to an embodiment.

FIG. 6 is a diagram illustrating the generation operation of the combined video signal performed by the video signal combining device according to an embodiment.

FIG. 7 is a diagram illustrating the generation operation of the combined video signal performed by the video signal combining device according to an embodiment.

FIG. 8 is a diagram illustrating the generation operation of the combined video signal performed by the video signal combining device according to an embodiment.

FIG. 9 is a block diagram illustrating the video signal combining device according to a comparative example.

FIG. 10 is a diagram illustrating the generation operation of the combined video signal performed by the video signal combining device according to the comparative example.

FIG. 11 is a schematic block diagram illustrating an example of the video processing device including a video signal combining part and a video processing part as a variation of the embodiment.

### DESCRIPTION OF THE EMBODIMENTS

Hereinafter, the embodiment of the video signal combining device of the disclosure is described in detail with reference to the drawings. In addition, in the embodiment, constituent elements having substantially the same function and configuration are given the same reference numerals to omit redundant description.

The video processing device such as the video signal combining device of the disclosure is capable of effectively saving the memory capacity and reducing the circuit area when combining the videos.

### (Description of Configuration)

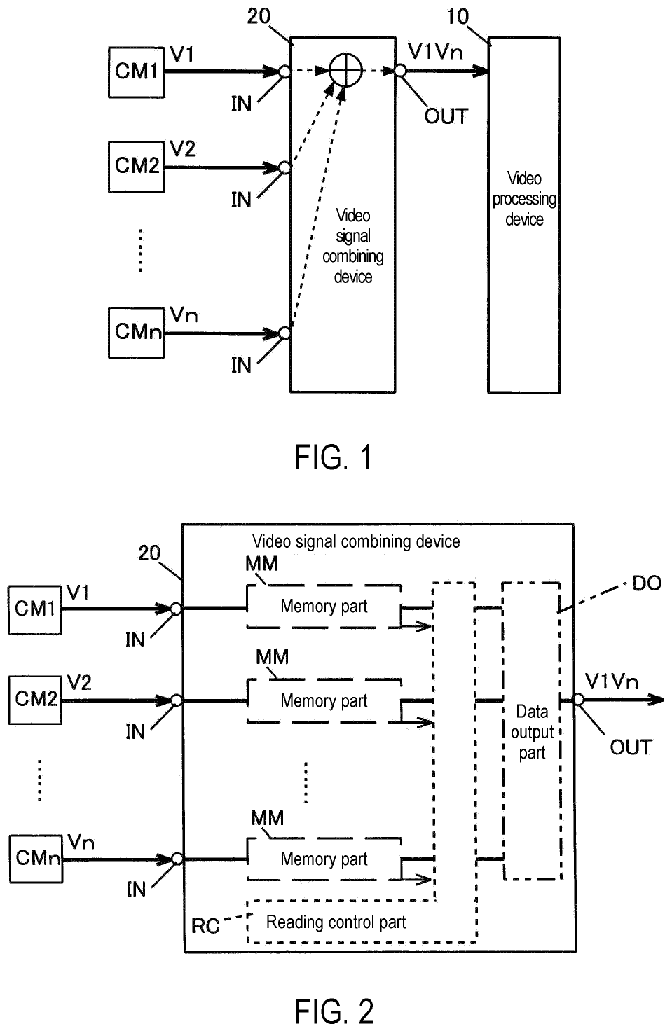

FIG. 1 is a schematic block diagram illustrating an example of a video processing system including a video signal combining device 20, which is the LSI (large scale integrated circuit) in the embodiment, connected to a video processing device 10. This video processing system may be used, for example, as a vehicle-mounted video processing system that acquires video signals from multiple cameras CM1 to CMn, respectively.

The cameras CM1 to CMn are connected to multiple input terminals IN of the video signal combining device 20. An output terminal OUT of the video signal combining device 20 is connected to an input terminal (not shown) of the video processing device 10.

The cameras CM1 to CMn generate video data (or video signals) V1 to Vn, respectively, and supply the same to the video signal combining device 20 by serial transmission.

The video signal combining device 20 combines multiple video data V1 to Vn from the cameras to generate the stream of one combined video data V1Vn (or combined video signal) containing the content of all of the video data. The video signal combining device 20 transmits the combined video signal V1Vn to the video processing device 10.

The video processing device 10 generates a combined video or the like to be displayed based on the video data V1Vn and, for example, outputs the generated video to a display (not shown).

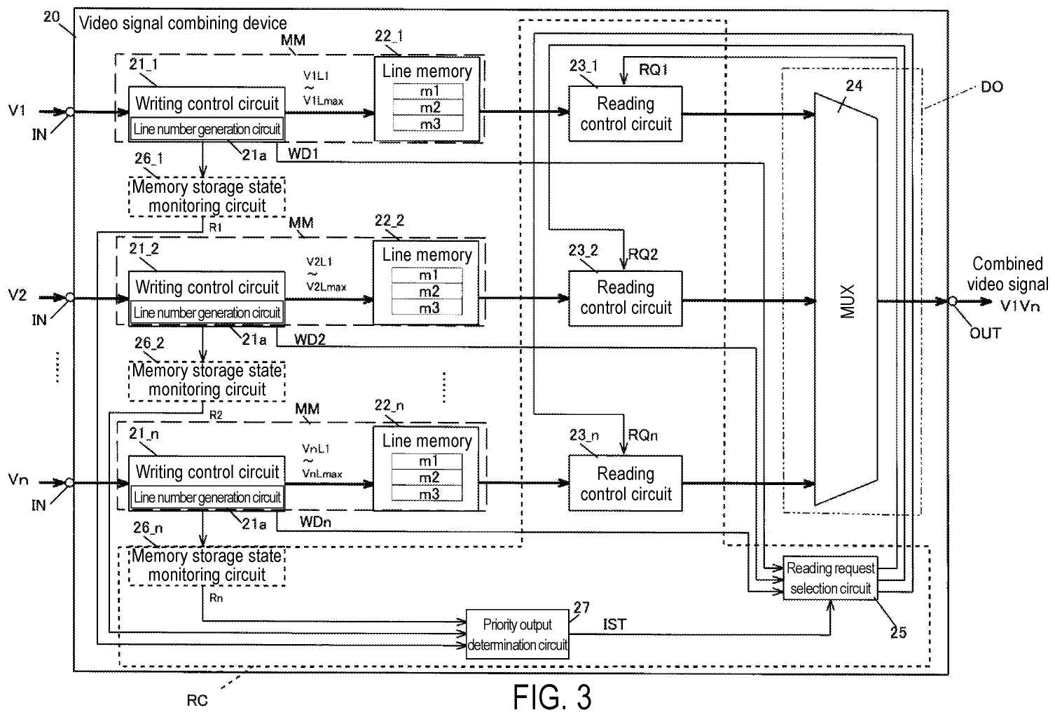

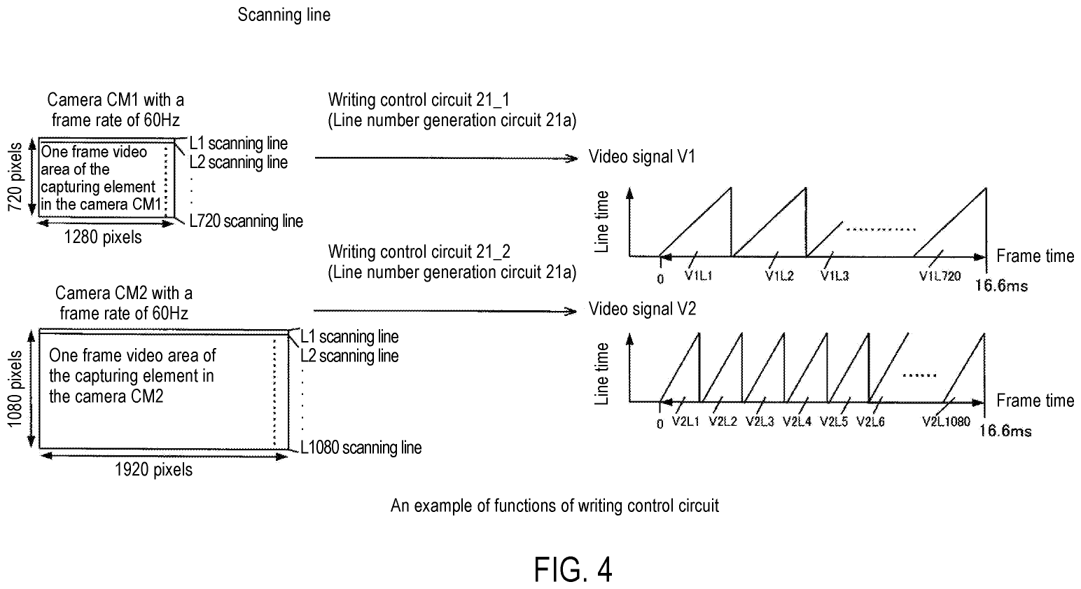

FIG. 2 and FIG. 3 are block diagrams illustrating the video signal combining device 20 according to the embodiment. The video signal combining device 20 of the embodiment is provided with the video data V1 to Vn from the cameras CM1 to CMn and has multiple memory parts MM, a reading control part RC, and a data output part DO. FIG. 4 is a diagram illustrating an example of the relationship between the video signals V1 to V2 (respective frame times and line times) and the frame rate of the video in the video signal combining device according to an embodiment.

The memory parts MM respectively include the writing control circuits 21_1, 21_2, . . . 21_n and the corresponding line memories 22_1, 22_2, . . . 22_n respectively connected thereto. The writing control circuits 21_1, 21_2, . . . 21_n respectively acquire the line data V1L1 to V1Lmax, V2L1 to V2Lmax, . . . VnL1 to VnLmax of the video signals V1 to Vn respectively input from the input terminals IN. The line data V1L1 to V1Lmax, V2L1 to V2Lmax, . . . VnL1 to VnLmax respectively input from the input terminals IN are respectively the output (video signals V1 to Vn) of the cameras CM1 to CMn.

In addition, the writing control circuits 21_1, 21_2, . . . 21_n sequentially write the acquired line data V1L1 to V1Lmax, V2L1 to V2Lmax, . . . VnL1 to VnLmax into the line memories 22_1, 22_2, . . . 22_n.

Moreover, each of the line memories 22_1, 22_2, . . . 22_n included in the memory parts MM to store the line data has three storage parts m1, m2, m3 of the same capacity that are to be sequentially written.

Further, the writing control circuits 21_1, 21_2, . . . 21_n output the writing completion signals WD1, WD2, . . . WDn to the reading request selection circuit 25 (which is described later) of the reading control part RC when the line data is written and filled in every of the storage parts m1, m2, m3 of each of the line memories.

As shown in FIG. 3, each of the writing control circuits 21_1, 21_2, . . . 21_n includes a line number generation circuit 21a.

Here, FIG. 4 illustrates the relationship between the functions of each of the writing control circuits (line number generation circuit 21a), the video signals V1 and V2 of the cameras CM1 and CM2 processed by the writing control circuits, and the line data V1L1 to V1Lmax, V2L1 to V2Lmax, . . . VnL1 to VnLmax of the video data acquired from one frame video area of the capturing element in the camera.

As shown in FIG. 4, when the one frame video area of the capturing element in the camera CM1 with a frame rate of 60 Hz (fps) is, for example, 1280 pixels×720 pixels, the video signal V1 of the camera CM1 is taken into the writing control circuit 21_1 as continuous 720 data blocks of line data V1L1 to V1L720 within the frame time of 16.6 ms.

The line number generation circuit 21a of the writing control circuit 21_1 generates line numbers L1 to L720 (corresponding to scanning lines L1 to L720 that increment by one for each line from the top to the bottom of the one frame video area of the capturing element in the camera CM1 in FIG. 4 (where the maximum scanning line Lmax is L720) to be added to the line data V1L1 to V1L720 written in the line memory 22_1, generates an identifier V1 (video signal identifier) for the camera CM1, and assigns the same to each of the line data. As an example, the line numbers are numbers that increase by one for each transition from one line data V1L1 to the next line data V1L2 according to the scanning order. For example, in the case of 720 lines, 10 bits are required; and in the case of 1080 lines, 11 bits are required. Thus, 11 bits are added to the data.

Similarly, as shown in FIG. 4, when the one frame video area of the capturing element in the camera CM2 with a frame rate of 60 Hz (fps) is, for example, 1920 pixels×1080 pixels, the video signal V2 of the camera CM2 is taken into the writing control circuit 21_2 as continuous 1080 data blocks of line data V2L1 to V2L1080 within the frame time of 16.6 ms.

The line number generation circuit 21a of the writing control circuit 21_2 generates line numbers L1 to L1080 (corresponding to scanning lines L1 to L1080 that increment by one for each line from the top to the bottom of the one frame video area of the capturing element in the camera CM2 in FIG. 4 (where the maximum scanning line Lmax is L1080) to be added to the line data V2L1 to V2L1080 written in the line memory 22_2, generates an identifier V2 (video signal identifier) for the camera CM2, and assigns the same to each of the line data.

Thus, according to the video signal combining device 20 in the embodiment, the writing control circuits 21_1, 21_2, . . . 21_n respectively include line numbers L1 to Lmax and L1 to Lmax of the video data as well as the identifiers V1 to Vn (video signal identifiers) for the cameras CM1 to CMn in the line data V1L1 to V1Lmax, V2L1 to V2Lmax, . . . VnL1 to VnLmax. As a result, the decoding from the combined video data V1Vn (combined video signal) to be output becomes reliable. Furthermore, the above-mentioned line number assignment is just one example, and it is also possible to transmit control data different from the video data at the beginning and the end of a frame to determine the line numbers.

As shown in FIG. 3, each of the three storage parts m1, m2, m3 of the line memories 22_1, 22_2, . . . 22_n included in each of the memory parts MM has the same capacity to respectively store three scanning lines of the line data (line data of three consecutive scanning lines in the one frame video area of the capturing elements of the cameras CM1 and CM2 as shown in FIG. 4). In other words, each of the storage parts m1, m2, m3 has a capacity for storing one scanning line of the line data.

Furthermore, the reading control part RC shown in FIG. 3 monitors the storage state of the line data V1L1 to V1Lmax, V2L1 to V2Lmax, . . . VnL1 to VnLmax in the line memories 22_1, 22_2, . . . 22_n and reads the line data V1L1 to V1Lmax, V2L1 to V2Lmax, . . . VnL1 to VnLmax from determined one of the line memories 22_1, 22_2, . . . 22_n based on the storage state. In other words, the reading control part RC is a functional part, which reads each of the line data V1L1 to V1Lmax, V2L1 to V2Lmax, . . . VnL1 to VnLmax sequentially from the storage parts m1, m2, m3 of the line memories 22_1, 22_2, . . . 22_n in a first-in-first-out manner.

The reading control part RC includes reading control circuits 23_1, 23_2, . . . 23_n, memory storage state monitoring circuits 26_1, 26_2, . . . 26_n, a priority output determination circuit 27, and the reading request selection circuit 25.

The reading control circuits 23_1, 23_2, . . . 23_n respectively connect to the line memories 22_1, 22_2, . . . 22_n, read the line data V1L1 to V1Lmax, V2L1 to V2Lmax, . . . VnL1 to VnLmax respectively from the corresponding line memories (storage parts m1, m2, m3), and output the line data to the data output part DO.

The memory storage state monitoring circuits 26_1, 26_2, . . . 26_n monitor the writing of the line data V1L1 to V1Lmax, V2L1 to V2Lmax, . . . VnL1 to VnLmax of each of the writing control circuits 21_1, 21_2, . . . 21_n, which are respectively connected to the memory storage state monitoring circuits 26_1, 26_2, . . . 26_n, into the corresponding line memories 22_1, 22_2, . . . 22_n, respectively, and also monitor the reading of the line data V1L1 to V1Lmax, V2L1 to V2Lmax, . . . VnL1 to VnLmax performed by the corresponding reading control circuits therefrom, thereby monitoring the storage state of the line data V1L1 to V1Lmax, V2L1 to V2Lmax, . . . VnL1 to VnLmax in the corresponding line memories (storage parts m1, m2, m3), respectively. As the storage state, the memory storage state monitoring circuits 26_1, 26_2, . . . 26_n calculate, as the data storage rate, a value obtained by dividing a writing data quantity when the line data V1L1 to V1Lmax, V2L1 to V2Lmax, . . . VnL1 to VnLmax is written into all of the line memories 22_1, 22_2, . . . 22_n by a data quantity of the line data V1L1 to V1Lmax, V2L1 to V2Lmax, . . . VnL1 to VnLmax that is storable in the corresponding line memories 22_1, 22_2, . . . 22_n for each of the line memories 22_1, 22_2, . . . 22_n, and output the data storage rates R1, R2, . . . Rn to the priority output determination circuit 27. For example, a control value determined from the divided value is used as the data storage rate.

Here, the priority output determination circuit 27 performs monitoring and priority reading according to the following rules:
(1) When there is only one line memory (a storage part having unread line data) in which one scanning line of the line data has been written, read from that storage part. When there is only one storage part in the line memory outputting any one of the so-called writing completion signals WD1, WD2, . . . WDn, read from that storage part.
(2) When there are multiple line memories (storage parts having unread line data) in which one scanning line of the line data has been written, read from the line memory with less memory storable capacity. When there are two line memories outputting the so-called writing completion signals WD1, WD2, . . . WDn, read from the line memory with less memory storable capacity (i.e., data storage rates R1, R2, . . . Rn).
(3) The determination based on (1) and (2) is made when the reading of one line data is finished.
(4) The “memory storable capacity” is calculated as follows: [data quantity when line data is written into all of the line memories of the three storage parts m1, m2, m3]−(data quantity written into the line memories−read data).

In this way, the priority output determination circuit 27 determines, based on the storage state (data storage rates R1, R2, . . . Rn), a memory from which the line data V1L1 to V1Lmax, V2L1 to V2Lmax, . . . VnL1 to VnLmax are to be read among the line memories 22_1, 22_2, . . . 22_n and outputs a reading instruction (reading request signals RQ1, RQ2, . . . RQn) to the reading control circuits provided in the determined memory through the reading request selection circuit 25.

In this way, the reading request selection circuit 25 monitors the writing of the line data V1L1 to V1Lmax, V2L1 to V2Lmax, . . . VnL1 to VnLmax of the writing control circuits 21_1, 21_2, . . . 21_n, in particular, the completion of the writing (writing completion signals WD1, WD2, . . . WDn), and outputs reading request signals RQ1, RQ2, . . . RQn based on the reading instruction IST from the priority output determination circuit 27 to the reading control circuits 23_1, 23_2, . . . 23n.

In this way, the reading control part RC calculates the data storage rates R1, R2, . . . Rn based on the monitoring results of writing of the line data V1L1 to V1Lmax, V2L1 to V2Lmax, . . . VnL1 to VnLmax into each of the line memories 22_1, 22_2, . . . 22_n and reading of the line data V1L1 to V1Lmax, V2L1 to V2Lmax, . . . VnL1 to VnLmax from each of the line memories 22_1, 22_2, . . . 22_n.

The priority output determination circuit 27 compares the data storage rate of each set (i.e., a set of three storage parts) of the same number of storage parts m1, m2, m3 and selects the line data V1L1 to V1Lmax, V2L1 to V2Lmax, . . . VnL1 to VnLmax of the line memory of the set with the smallest data storage rate according to the above rule (2). In other words, as the storage state, the reading control part RC calculates the data storage rate for each of the line memories 22_1, 22_2, . . . 22_n and reads the line data from the line memory with the smallest data storage rate.

The data output part DO includes a multiplexer 24, which receives outputs from the reading control circuits 23_1, 23_2, . . . 23_n and selects and outputs the outputs from the reading control circuits provided in the memory determined by the priority output determination circuit 27, so as to output the video combining data. In other words, the data output part DO outputs the combined video data V1Vn (combined video signal) in which the line data V1L1 to V1Lmax, V2L1 to V2Lmax, . . . VnL1 to VnLmax read by the reading control circuits 23_1, 23_2, . . . 23_n is connected.

### (Description of Operation)

The video signal combining device 20 shown in FIG. 3 operates as follows to generate a combined video signal V1V2 from the high-definition video signal V1 with a resolution of 1280×720 and the full high-definition video signal V2 with a resolution of 1920×1080, as shown in FIG. 4 for example. The video signals V1 and V2 have the same write timing and the same frame rate of 60 Hz (fps).

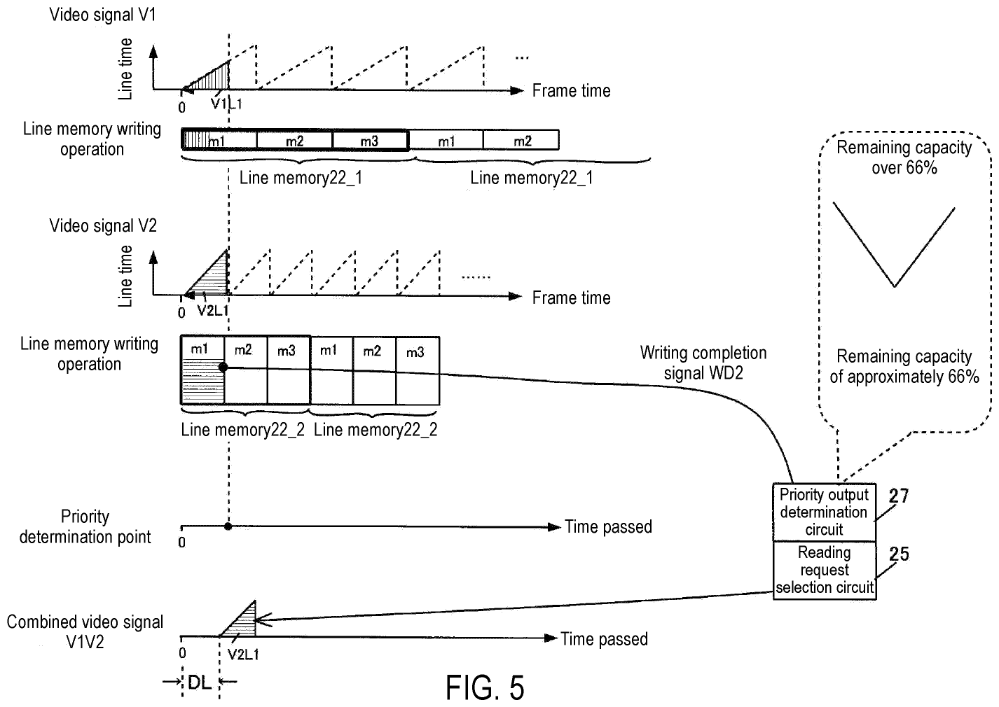

As shown in FIG. 5, the line data V1L1 and V2L1 of the video signals V1 and V2 is written into the line memories 22_1 and 22_2, respectively, by the writing control circuits 21_1, 21_2, . . . 21_n. As time elapses, the writing of the line data V2L1 to the storage part m1 of the line memory 22_2 is completed and the storage part m1 becomes full before the line data V1L1 is stored in the line memory 22_1. The priority output determination circuit 27 determines a reading priority based on the remaining capacity of the line memories for three scanning lines (for every three storage parts) and outputs the line data V2L1 to the multiplexer 24 for the video combining data through the reading request selection circuit 25 and the reading control circuit 23_2 according to the above-mentioned rules (1) and (3). The output combined video signal V1V2 has a delay DL from the write timing.

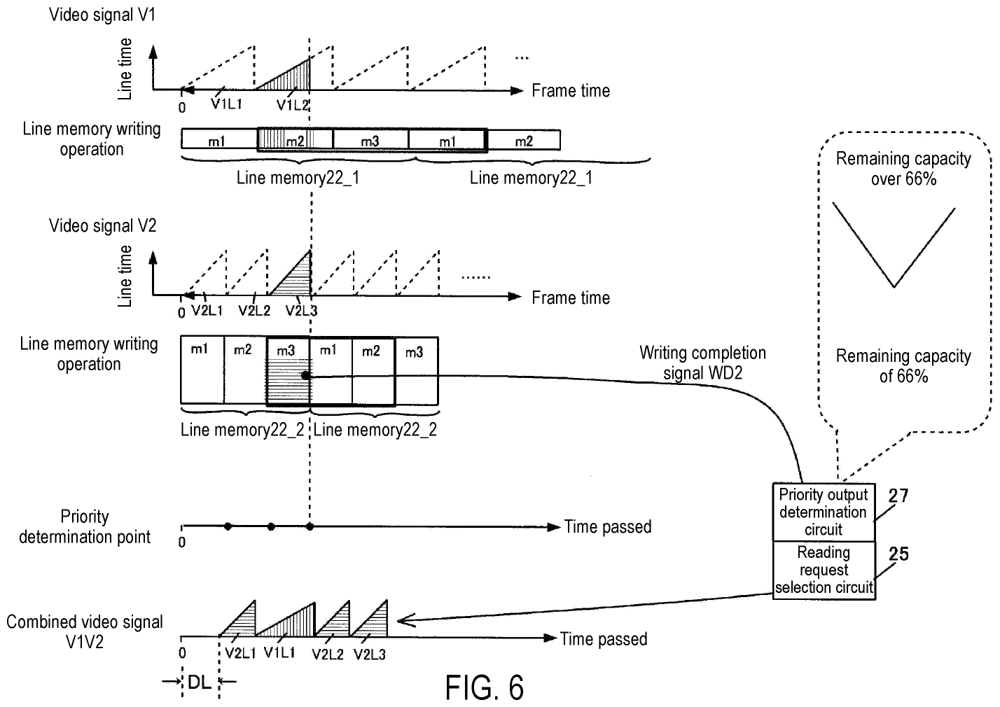

As time elapses, as shown in FIG. 6, the line data V1L1 and V2L3 of the video signals V1 and V2 are respectively written into the corresponding line memories by the corresponding writing control circuits, and the priority output determination circuit 27 outputs the line data V1L1, V2L2, V2L3 to the multiplexer 24 for the video combining data through the reading request selection circuit 25 and the reading control circuit 23_2 according to the above-mentioned rules (1) and (3).

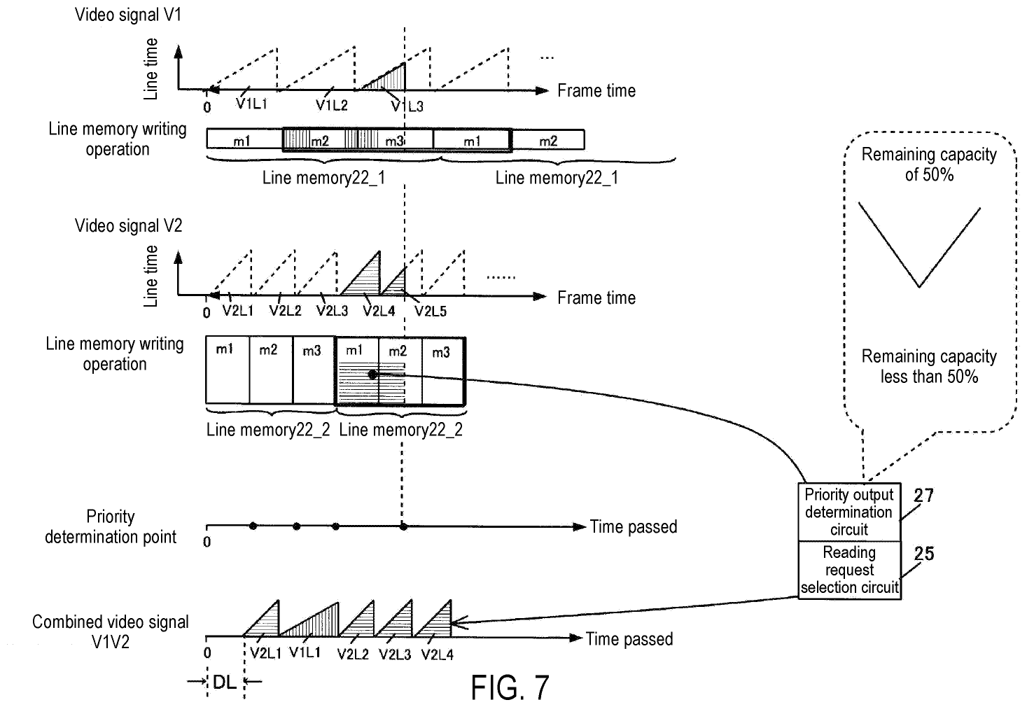

As time elapses, as shown in FIG. 7, the line data V1L2, V1L3, V2L4, V2L5 of the video signals V1 and V2 is written into the corresponding line memories by the corresponding writing control circuits, and the priority output determination circuit 27 outputs the line data V2L4 to the multiplexer 24 for the video combining data through the reading request selection circuit 25 and the reading control circuit 23_2 according to the above-mentioned rules (2) and (3).

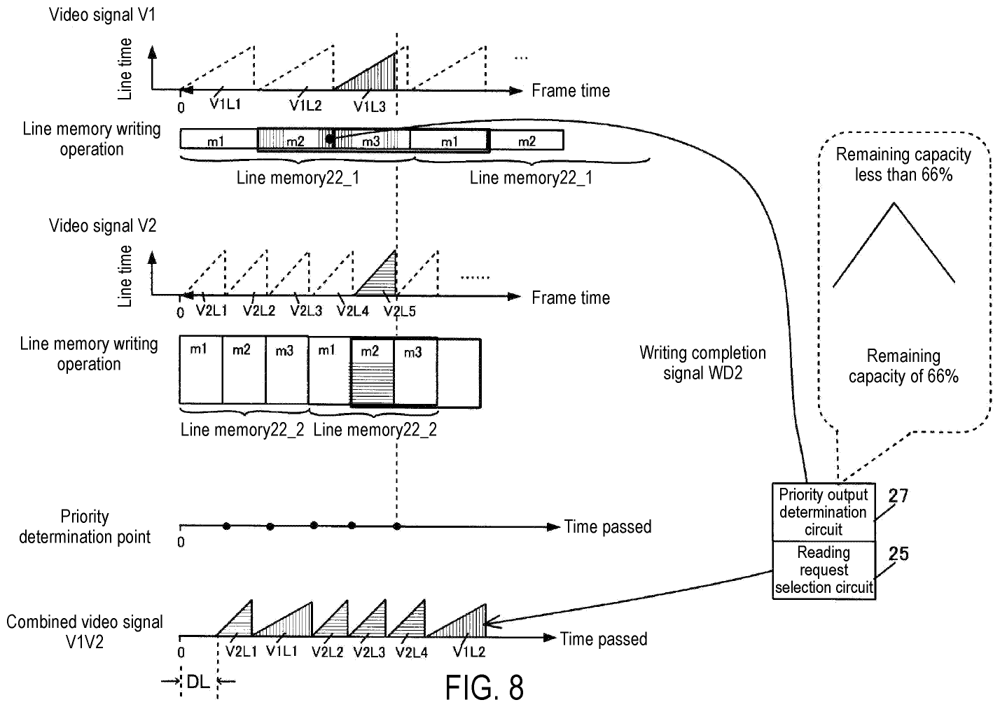

As time elapses, as shown in FIG. 8, the line data V1L3 and V2L5 of the video signals V1 and V2 are further respectively written into the corresponding line memories by the corresponding writing control circuits, and at the time point when the writing completion signal WD2 is output by the line memory 22_2, the priority output determination circuit 27 outputs the line data V1L2 to the multiplexer 24 for the video combining data through the reading request selection circuit 25 and the reading control circuit 23_1 according to the above-mentioned rules (2) and (3).

### (Description on Effect)

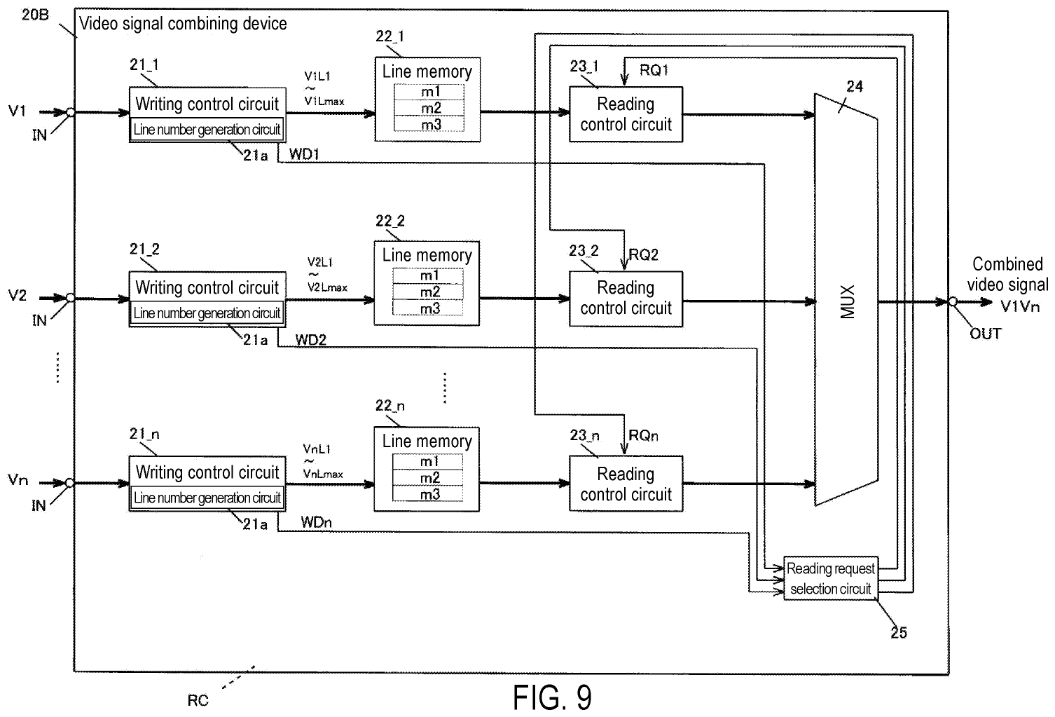

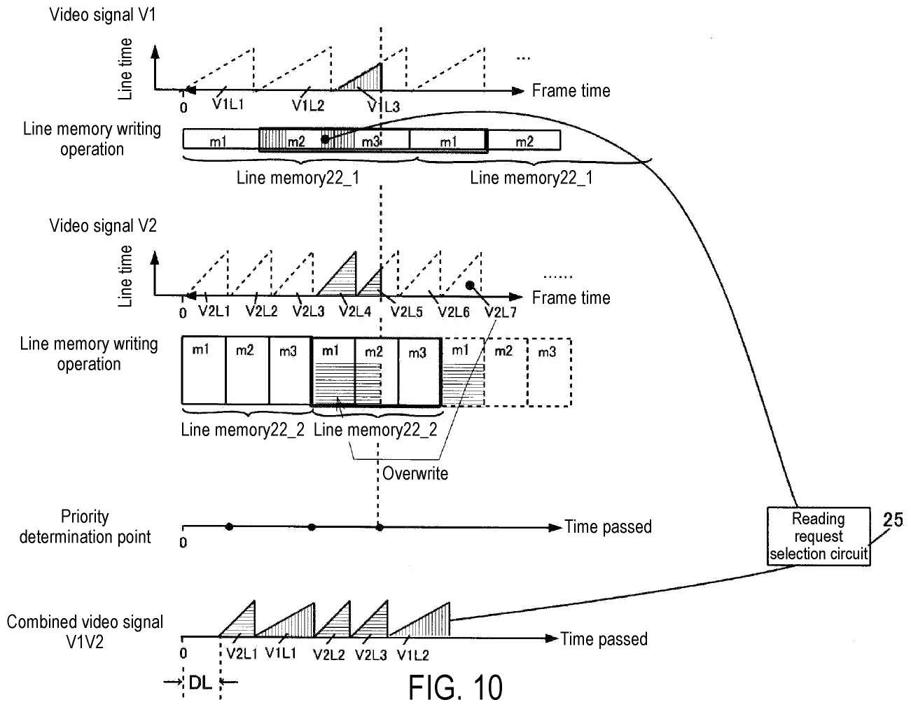

In order to verify the effects of this embodiment, a video signal combining device 20B of the comparative example with a configuration similar to the video signal combining device 20 of this embodiment, except for the absence of the memory storage state monitoring circuit and the priority output determination circuit shown in FIG. 9, was prepared.

FIG. 10 is a diagram illustrating that the video signal combining device 20B in the comparative example operated similarly to this embodiment, showing the generation operation of the combined video signal performed by the video signal combining device of the comparative example before the time point shown in FIG. 7 of this embodiment.

As shown in FIG. 10, in the video signal combining device 20B in the comparative example, the line data V1L2 of the video signal V1 was selected by the reading request selection circuit 25, and the line data V1L2 was output to the multiplexer 24 for video combining data through the reading control circuits 23_3. As a result, in the subsequent operation, the line data V2L7 was overwritten onto the line data V2L4 in the storage part m1 of the line memory 22_2 of the video signal V2, causing the output of the line data V2L4 of the video signal V2 from the video combining data to be omitted and resulting in a failure of the signal combining operation.

From the above comparison results, it has been confirmed that in the video signal combining device 20 of this embodiment, which includes the memory storage state monitoring circuit and the priority output determination circuit, the overwriting of line data in the line memory during the signal combining operation is avoided, ensuring reliable execution of decoding from the output combined video data (combined video signal).

By monitoring the memory storage amount for the input video signals and then determining which input video is to be output, the video signal combining device of this embodiment achieves advantageous effects of saving memory during the operation and further reducing the circuit area in the device.

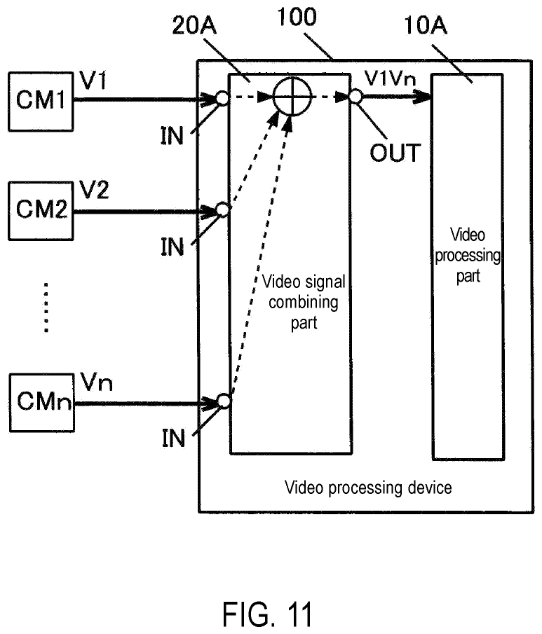

Furthermore, although this embodiment has described the video signal combining device 20, as shown in FIG. 11, as a variation, a video processing device 100 using the video signal combining device 20 as a video signal combining part 20A and including a video processing part 10A for processing the video combining data V1Vn output therefrom is also encompassed by the disclosure.

What is claimed is:

1. A video signal combining device, comprising:
a plurality of memory parts, each having a plurality of line memories, and respectively acquiring line data of video signals respectively input from a plurality of input terminals and sequentially writing and storing the acquired line data into the line memories;
a reading control part, sequentially reading the line data from any one of the line memories in a first-in-first-out manner; and
a data output part, outputting video combining data in which the line data read by the reading control part is connected,
wherein the reading control part reads the line data from determined one of the line memories based on a storage state of the line data in the line memories.

2. The video signal combining device according to claim 1, wherein as the storage state, the reading control part calculates, as a data storage rate, a value obtained by dividing a writing data quantity when the line data is written into all of the line memories by a data quantity of line data that is storable in the line memories for each of the line memories, and reads the line data from a line memory with a smallest data storage rate.

3. The video signal combining device according to claim 2, wherein the reading control part calculates the data storage rate based on monitoring results of writing of the line data into each of the line memories and reading of the line data from each of the line memories.

4. The video signal combining device according to claim 3, wherein:
each of the memory parts comprises a writing control circuit for writing the line data into the line memories, and
the reading control part comprises:
a plurality of reading control circuits, reading and outputting the line data from each of the line memories;
a memory storage state monitoring circuit, monitoring writing of the line data of each of the writing control circuits and reading of the line data of each of the reading control circuits, and monitoring the storage state of the line data in each of the line memories;
a priority output determination circuit, determining, based on the storage state, a memory from which the line data is to be read among the line memories, and outputting a reading instruction to the reading control circuits provided in the determined memory; and
a reading request selection circuit, monitoring writing of the line data of the writing control circuit and outputting a reading request signal based on the reading instruction from the priority output determination circuit to the reading control circuits,
wherein the data output part comprises a multiplexer, which receives outputs from the reading control circuits and selects and outputs the outputs from the reading control circuits provided in the memory determined by the priority output determination circuit, so as to output the video combining data.

5. The video signal combining device according to claim 4, wherein each of the line memories comprises a plurality of storage parts, and
the priority output determination circuit compares the data storage rate of a set of the same number of the storage parts, and selects the line data in the line memories of the set with the smallest data storage rate.

6. The video signal combining device according to claim 1, wherein the line data respectively input from the input terminals are outputs of a plurality of cameras, respectively.

7. A video processing device, comprising:
a plurality of memory parts, each having a plurality of line memories, and respectively acquiring line data of video signals respectively input from a plurality of input terminals and sequentially writing and storing the acquired line data into the line memories;
a reading control part, sequentially reading the line data from any one of the line memories in a first-in-first-out manner and reading the line data from determined one of the line memories based on a storage state of the line data in the line memories;
a data output part, outputting video combining data in which the line data read by the reading control part is connected; and
a video processing part, processing the output video combining data.
